(19) United States
(12) Patent Application Publication
(10) Pub. No.: US 2026/0336662 A1
(43) Pub. Date: Oct. 29, 2026

(54) BARRIER RATE-GUIDED MODEL PREDICTIVE PATH INTEGRAL (MPPI) FOR COLLISION AWARE AND NARROW ENVIRONMENT NAVIGATION

(71) Applicant: Toyota Motor Engineering & Manufacturing North America, Inc., Plano, TX (US)

(72) Inventors: Hardik Parwana, Ann Arbor, MI (US); Georgios Fainekos, Novi, MI (US); Bardh Hoxha, Canton, MI (US); Hideki Okamoto, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/188,556

(22) Filed: Apr. 24, 2025

(51) Int. Cl. B60W 60/00; B60W 50/00

(52) U.S. Cl. CPC B60W 60/0015; B60W 50/0097; B60W 2300/14; B60W 2554/80

(57) ABSTRACT

Systems, methods, and other embodiments described herein relate to improving the resiliency and performance of a robotic device, such as an autonomous tractor trailer, against collisions and navigation in challenging confined environments. In one embodiment, a method includes acquiring sensor data about a surrounding environment of a device. The method includes sampling control input sequences representing separate trajectories for navigating the device through the surrounding environment according to a control barrier function (CBF) and the sensor data. The method includes determining costs for the control input sequences according to model predictive path integral (M PPI). The method includes determining a control trajectory according to a weighted average of the control input sequences based, at least in part, on the costs. The method includes providing the control trajectory.

### TECHNICAL FIELD

The subject matter described herein relates, in general, to improving the resiliency of a robotic device against collisions and, more particularly, to using a novel M PPI approach with control barrier functions for generating control trajectories.

### BACKGROUND

Autonomous robotic systems have increasingly incorporated learning-based methods to enhance real-time decision-making, improve efficiency, and ensure safe navigation in constrained environments. These applications range from active learning for estimating unknown quantities to leveraging pre-trained components such as learned dynamics models or distance fields for obstacle avoidance. The ability to plan kinodynamic paths in real-time while satisfying safety constraints is central for enabling robust and adaptive robotic behavior.

Model Predictive Path Integral (M PPI) control and Control Barrier Functions (CBFs) have emerged as popular approaches in robotic systems. M PPI is a sampling-based method that solves unconstrained optimal control problems by generating multiple control input trajectories, evaluating their performance based on a user-defined cost function, and selecting an optimal control policy. However, standard M PPI lacks strict constraint enforcement, as it only incorporates constraints in a soft manner via penalty terms in the cost function. This limitation makes M PPI susceptible to constraint violations, particularly in scenarios where few samples are available or when precise constraint satisfaction is required.

Conversely, CB F-based controllers employ barrier functions to enforce strict inequality constraints that govern the rate of change of the system state, ensuring that a robot remains within a safe set. While effective for safety-critical applications, CBF-based controllers often lead to myopic decision-making and suboptimal trajectory generation due to their reliance on local constraint enforcement. Accordingly, existing approaches encounter difficulties when generating optimal controls.

### SUMMARY

Example systems and methods relate to a manner of improving the resiliency of a robotic device, such as an autonomous tractor trailer, against collisions. As previously noted, real-time path planning while ensuring safety constraints for autonomous navigation of robotic devices is a complex task that encounters different difficulties depending on the provided approach. For example, while M PPI may be able to generate control input trajectories for unconstrained problems, this approach can encounter issues with violating constraints, which is generally unacceptable when considering the navigation of a device such as a vehicle through a real-world environment. Moreover, CBF can effectively generate trajectories that ensure safety constraints are followed but may not provide an optimal solution, thereby resulting in inefficient trajectories.

Therefore, in at least one approach, an inventive system implements a combined approach that leverages concepts of both M PPI and CBF to efficiently enforce safety constraints and generate control input trajectories. For example, in at least one aspect, the inventive system leverages equality constraints in place of inequalities within M PPI that allow the robotic device to closely approach obstacles without compromising safety. The inventive system operates by, for example, acquiring sensor data about the surrounding environment and the device (e.g., robot, vehicle, etc.) for which the control trajectory is to be generated. The system then samples control input sequences representing different trajectories for navigating the device through the surrounding environment. In at least one approach, sampling the control inputs involves a projection operation that restricts the samples along manifolds defined by the equality constraints. These manifolds represent safe trajectories through the environment.

The inventive system can then determine costs associated with the sampled inputs according to M PPI. The costs may be decomposed into multiple parts, such as a safety cost and a convergence cost. The safety cost promotes a positive barrier rate while the convergence cost may be a specifically defined cost that promotes convergence to a desired state. Once the system determines the costs, the system generates a control trajectory as a weighted average of the control input sequences where the costs are used to define the weights. The system can then use the control trajectory to control the device. In this way, the inventive system is able to overcome the noted difficulties to efficiently generate the trajectory.

In one embodiment, a planning system is disclosed. The planning system includes one or more processors and a memory communicably coupled to the one or more processors. The memory stores a control module including instructions that, when executed by the one or more processors, cause the one or more processors to acquire sensor data about a surrounding environment of a device. The instructions include instructions to sample control input sequences representing separate trajectories for navigating the device through the surrounding environment according to a control barrier function (CBF) and the sensor data. The instructions include instructions to determine costs for the control input sequences according to model predictive path integral (M PPI). The instructions include instructions to determine a control trajectory according to a weighted average of the control input sequences based, at least in part, on the costs. The instructions include instructions to provide the control trajectory.

In one embodiment, a non-transitory computer-readable medium including instructions that, when executed by one or more processors, cause the one or more processors to perform one or more functions is disclosed. The instructions include instructions to acquire sensor data about a surrounding environment of a device. The instructions include instructions to sample control input sequences representing separate trajectories for navigating the device through the surrounding environment according to a control barrier function (CBF) and the sensor data. The instructions include instructions to determine costs for the control input sequences according to model predictive path integral (M PPI). The instructions include instructions to determine a control trajectory according to a weighted average of the control input sequences based, at least in part, on the costs. The instructions include instructions to provide the control trajectory.

In one embodiment, a method is disclosed. In one embodiment, the method includes acquiring sensor data about a surrounding environment of a device. The method includes sampling control input sequences representing separate trajectories for navigating the device through the surrounding environment according to a control barrier function (CBF) and the sensor data. The method includes determining costs for the control input sequences according to model predictive path integral (M PPI). The method includes determining a control trajectory according to a weighted average of the control input sequences based, at least in part, on the costs. The method includes providing the control trajectory.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a planning system associated with implementing an M PPI-CBF approach to trajectory generation.

FIG. 3 illustrates a diagram of a planning system within a cloud-computing environment.

FIG. 4 is a flowchart illustrating one embodiment of a method associated with generating a control trajectory.

FIG. 5 illustrates a diagram of an example scenario associated with using methods described herein to navigate a robotic device.

FIGS. 6-7 are diagrams of opposing scenarios in which the planning system is implemented to control a tractor trailer.

FIGS. 8-9 illustrate additional diagrams of opposing scenarios in which the planning system is implemented to control an articulated vehicle.

### DETAILED DESCRIPTION

Systems, methods, and other embodiments associated with a manner of improving the resiliency of a robotic device against collisions is disclosed. As previously noted, real-time path planning while ensuring safety constraints for autonomous navigation of robotic devices is a complex task that encounters different difficulties depending on the provided approach. For example, while MPPI may be able to generate control input trajectories for unconstrained problems, this approach can encounter issues with violating constraints, which is generally unacceptable when considering the navigation of a device such as a vehicle through a real-world environment. Moreover, CBF can effectively generate trajectories that ensure safety constraints are followed but may not provide an optimal solution, thereby resulting in inefficient trajectories.

To address these difficulties, various arrangements described herein introduce a novel integration of M PPI and CBF-inspired conditions for sampling-based kinodynamic planning. Unlike prior methods that require solving constrained optimization problems, approaches outlined herein enforce CBF conditions as equality constraints by introducing a parametric linear class-K function and treating its parameter as an additional state in an augmented system. This formulation allows M PPI to directly manage constraint maintenance without the need for separate constraint satisfaction layers, leading to improved efficiency and safety performance.

In particular, present arrangements introduce a control input projection operation. Since the equality constraints introduce manifold structures that random control inputs may not satisfy, the projection operation ensures that sampled trajectories remain within feasible regions. This enables the system to achieve constraint satisfaction while maintaining the benefits of MPPI's sampling-based optimization.

Furthermore, the system also enhances safety by, in at least one arrangement, leveraging Nagumo's theorem to reinforce constraint maintenance at the boundary of safe regions. By adapting class-K function parameters dynamically within the M PPI framework, the system effectively balances safety and performance without the need for extensive tuning of penalty weights. This arrangement is the first approach that integrates M PPI with multiple state-and-control dependent equality constraints, extends set invariance theory to enforce constraints within a higher-dimensional lifted state space, and employs M PPI for adaptive design of CB F parameters. This novel formulation provides a more computationally efficient and effective solution for real-time, safety-aware kinodynamic motion planning in complex environments.

Therefore, in at least one approach, an inventive system implements a combined approach that leverages concepts of both M PPI and CBF to efficiently enforce safety constraints and generate control input trajectories. For example, in at least one aspect, the inventive system leverages equality constraints within M PPI that allow the robotic device to closely approach obstacles without compromising safety. The inventive system operates by, for example, acquiring sensor data about the surrounding environment and the device (e.g., robot, vehicle, etc.) for which the control trajectory is to be generated. The system then samples control input sequences representing different trajectories for navigating the device through the surrounding environment. In at least one approach, sampling the control inputs involves a projection operation that restricts the samples along manifolds defined by equality constraints. These manifolds represent safe trajectories through the environment.

The inventive system can then determine costs associated with the sampled inputs according to M PPI. The costs may be decomposed into multiple parts, such as a safety cost and a convergence cost. The safety cost promotes a positive barrier rate while the convergence cost may be a specifically defined cost that promotes convergence to a desired state. Once the system determines the costs, the system generates a control trajectory as a weighted average of the control input sequences where the costs are used to define the weights. The system can then use the control trajectory to control the device. In this way, the inventive system is able to overcome the noted difficulties to efficiently generate the trajectory.

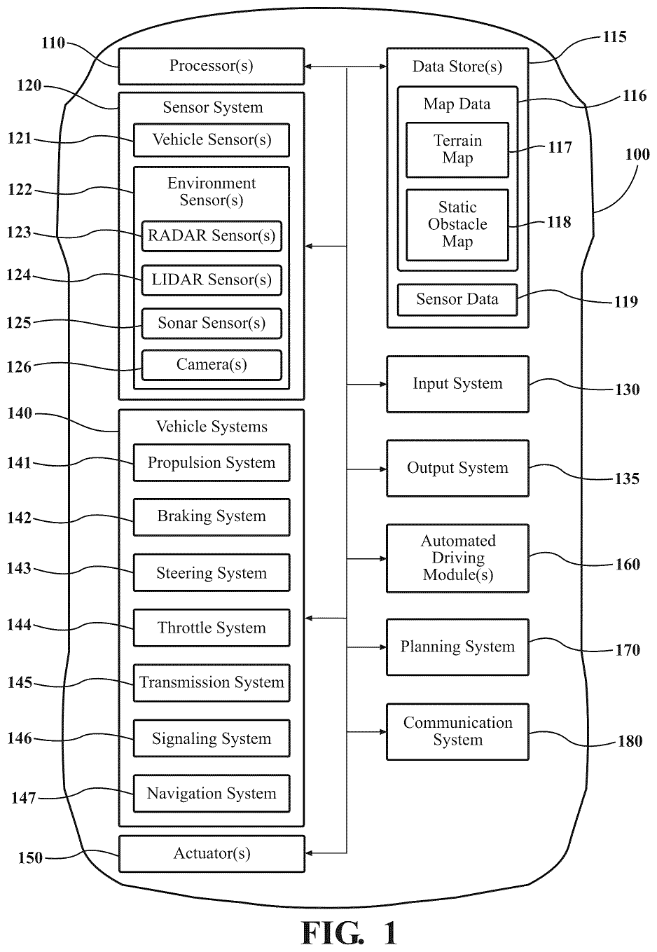

Referring to FIG. 1, an example of a vehicle 100 is illustrated. As used herein, a “vehicle” is any form of powered transport. In one or more implementations, the vehicle 100 is an automobile, such as a passenger vehicle or a tractor trailer. While arrangements will be described herein with respect to automobiles, it will be understood that embodiments are not limited to automobiles. In some implementations, the vehicle 100 may be any device that, for example, transports passengers. In various approaches, the vehicle 100 is an automated vehicle. The vehicle 100 may operate manually, autonomously, semi-autonomously, or with the assistance of various advanced driving assistance systems (A DAS).

In any case, the vehicle 100 also includes various elements. It will be understood that, in various embodiments, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within the vehicle 100, while further components of the system are implemented within a cloud-based environment, as discussed further subsequently.

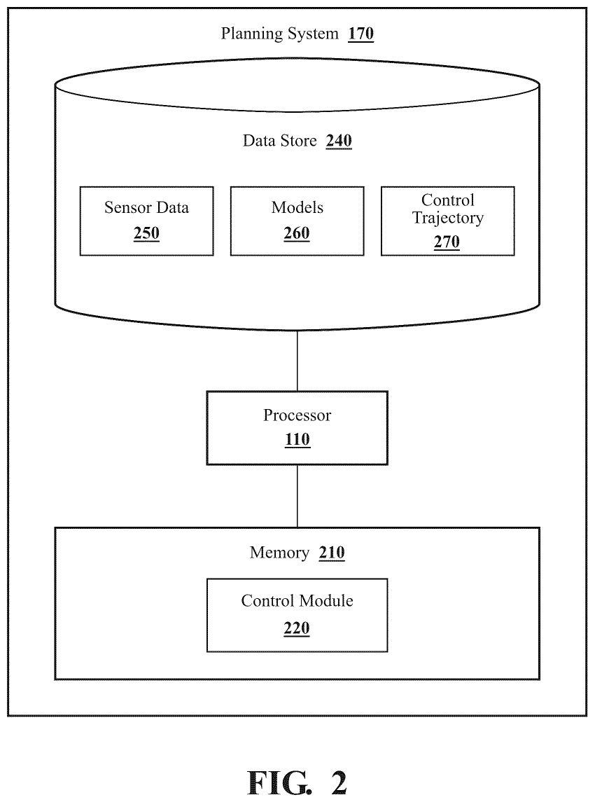

Some of the possible elements of the vehicle 100 are shown in FIG. 1 and will be described along with subsequent figures. However, a description of many of the elements in FIG. 1 will be provided after the discussion of FIGS. 2-6 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 100 includes a planning system 170 that is implemented to perform methods and other functions as disclosed herein relating to determining trajectories for navigating a surrounding environment.

Moreover, the planning system 170, as provided for within the vehicle 100, functions, in at least one approach, in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a communication protocol, such as a WiFi, DSRC, V2I, V2V, or another suitable protocol for communicating between the vehicle 100 and other entities in the cloud environment. Moreover, the communication system 180, in one arrangement, further communicates according to a protocol, such as the global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the planning system 170 can leverage various wireless communication technologies to provide communications to other entities, such as members of the cloud-computing environment.

With reference to FIG. 2, one embodiment of the planning system 170 is further illustrated. The planning system 170 is shown as including a processor 110 from the vehicle 100 of FIG. 1. Accordingly, the processor 110 may be a part of the planning system 170, the planning system 170 may include a separate processor from the processor 110 of the vehicle 100 or the planning system 170 may access the processor 110 through a data bus or another communication path. In further aspects, the processor 110 is a cloud-based resource. Thus, the processor 110 may communicate with the planning system 170 through a communication network or may be co-located with the planning system 170. In one embodiment, the planning system 170 includes a memory 210 that stores a control module 220. The memory 210 is a random-access memory (RAM), read-only memory (ROM), a hard-disk drive, a flash memory, or other suitable memory (either volatile or non-volatile) for storing the control module 220 and/or other information used by the planning system 170. The module 220 is, for example, computer-readable instructions within the physical memory 210 that, when executed by the processor 110, cause the processor 110 to perform the various functions disclosed herein.

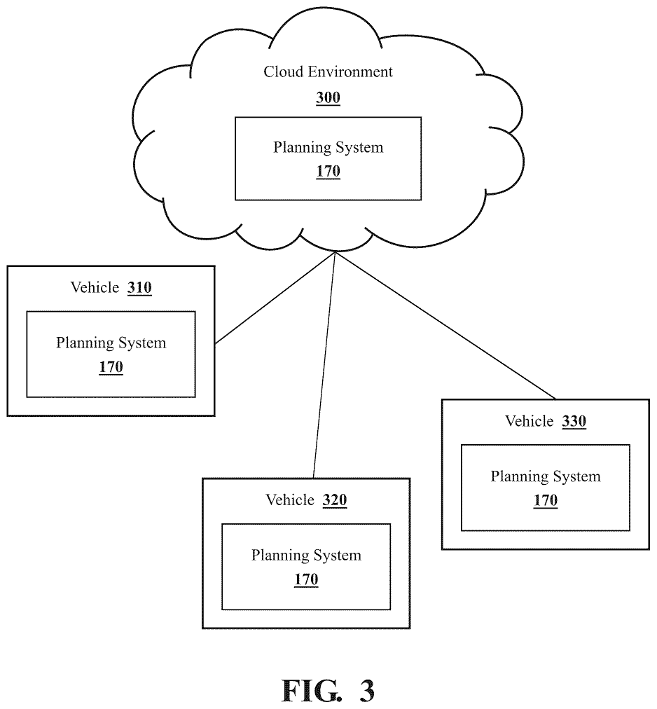

As previously noted, the planning system 170 may be further implemented as part of a cloud-based system that functions within a cloud environment 300, as illustrated in relation to FIG. 3. That is, for example, the planning system 170 may acquire data (e.g., telematics data, sensor data, etc.) from various entities and/or offload processing tasks to a cloud-based instance of the planning system 170. In one or more approaches, the cloud environment 300 may facilitate processing of complex tasks and/or sharing of data between entities. In one or more arrangements, the planning system 170 is implemented as separate vehicle-side and cloud-side instances, including one or more of vehicles 310, 320, and 330 and a cloud-based server within the cloud environment 300. Accordingly, as shown, the planning system 170 may include separate instances within one or more entities of the cloud-based environment 300, such as servers, and also instances within vehicles that function to acquire, analyze, and distribute the noted information.

Continuing with FIG. 2 and a general embodiment of the planning system 170, in one or more arrangements, the planning system 170 includes a data store 240. The data store 240 is, in one embodiment, an electronic data structure (e.g., a database) stored in the memory 210 or another electronic memory and that is configured with routines that can be executed by the processor 110 for analyzing stored data, providing stored data, organizing stored data, and so on. Thus, in one embodiment, the data store 240 stores data used by the control module 220 in executing various functions. In one embodiment, the data store 240 includes the sensor data 250, models 260, a control trajectory 270, and/or other information that is used by the module 220. It should be appreciated that while the data store 240 is shown as including the sensor data 250, the models 260, and the control trajectory 270, separate instances of the planning system 170 may implement the data store 240 to include different sets of information.

In any case, the control module 220 includes instructions that function, in at least one arrangement, to control the processor 110 to acquire the sensor data 250 about a surrounding environment of the vehicle 100. The planning system 170 captures observations of the surrounding environment in the form of the sensor data 250 that the planning system 170 can process into observations that are processed into features specifying objects, spatial relationships, etc.

Accordingly, the control module 220 generally includes instructions that cause the processor 110 to control one or more sensors of the vehicle 100 to generate observations about the surrounding environment. Broadly, an observation, as acquired by the control module 220, is information about a particular driving environment (e.g., roadway) and objects present in the driving environment as perceived by at least one sensor. Thus, the observation is generally a group of one or more data that can be processed into a derived determination about the environment.

The control module 220, in one embodiment, controls respective sensors of the vehicle 100 to provide the data inputs in the form of the sensor data 250. The control module 220 may further process the sensor data 250 into separate observations of the surrounding environment. For example, the control module 220, in one approach, fuses data from separate sensors to provide an observation about a particular aspect of the surrounding environment. By way of example, the sensor data 250 itself, in one or more approaches, may take the form of separate images, radar returns, LIDAR returns, and so on. The control module 220 may derive determinations (e.g., location, pose, characteristics, etc.) from the sensor data 250 and fuse the data for separately identified aspects of the surrounding environment, such as surrounding vehicles, pedestrians, and so on. The control module 220 may further extrapolate the sensor data 250 into an observation by, for example, correlating the separate instances of the sensor data 250 into a meaningful observation about an object beyond an instantaneous data point. For example, the control module 220 may track a pedestrian over many data points to provide an indication of a trajectory. In one arrangement, the control module 220 applies a vision model to images in the sensor data 250 to extract features representing objects and other aspects depicted in the images. In a similar manner, the control module 220 can process other types of data (e.g., radar, LiDAR, etc.) into features and then merge the features together that represent the same elements.

Additionally, while the control module 220 is discussed as controlling the various sensors to provide the sensor data 250, in one or more embodiments, the control module 220 can employ other techniques that are either active or passive to acquire the sensor data 250. For example, the control module 220 may passively sniff the sensor data 250 from a stream of electronic information provided by the various sensors or other modules/systems in the vehicle 100 to further components within the vehicle 100. Moreover, the sensor data 250 may include information about the vehicle 100 itself, such as a location, a speed, IM U data, and so on. Thus, the sensor data 250, in one embodiment, represents a combination of perceptions acquired from multiple sensors including both externally facing and internally facing.

Of course, depending on the sensors that the vehicle 100 or another entity includes, the available sensor data 250 that the planning system 170 can harvest may vary. As one example, according to a particular implementation, the vehicle 100 may include different types of cameras or placements of multiple cameras. When acquiring the sensor data 250, the control module 220 may acquire various electronic inputs that originate from the vehicle 100, which may be stored in the data store 240 of the planning system 170 as the sensor data 250 and processed according to various algorithms, such as machine learning algorithms, heuristics, and so on. Accordingly, the planning system 170, in one approach, uses the noted sensor data 250 to perceive and assess the surrounding environment along with a current state of the vehicle 100 itself.

Continuing with the elements of the data store 240, the models 260 may include various models, such as machine-learning models, statistical models, heuristics, and other processes used by the planning system 170 to process the sensor data 250 and generate the control trajectory 270. For example, the models 260 may include a signed distance field (SDF) model, a trajectory model, one or more perception models, and so on. The SDF model is trained to generate signed distance fields that provide distances to objects in the environment relative to a geometry of the device (i.e., vehicle, tractor trailer, etc.). Thus, the planning system 170 is able to use SDFs to model the geometry of the body of the vehicle 100 from which distances to the environment (e.g., objects and surfaces in the surrounding environment) can be determined instead of modeling the vehicle 100 as a single point, for example. In at least one approach, the SDF model is a machine-learning algorithm, such as a transformer network, a convolutional neural network (CNN), or another machine-learning architecture.

The models 260 may further include a trajectory model that implements the general framework of the combined M PPI-CBF approach. This model may be a heuristic or other algorithm that implements the constraints and cost determinations associated with M PPI-CBF. Additionally, as noted, the planning system 170 may implement various perception models, such as CNNs, vision-based transformers, and so on that function to, for example, process and fuse the sensor data 250 into observations of the surrounding environment. Lastly, the data store 240 includes the control trajectory 270. It should be appreciated that while the control trajectory 270 is recited as a single discrete element, in practice, the planning system 170 is, for example, iteratively generating the control trajectory 270 at subsequent time steps to maintain an updated path for the vehicle 100. The control trajectory 270 itself is, in at least one arrangement, a path that defines positions and speeds for the vehicle 100 to navigate the surrounding environment. In further arrangements, the control trajectory 270 may define specific control inputs for different timesteps to achieve a specific trajectory for the vehicle 100. In any case, the planning system 170 is able to leverage the control trajectory 270 to automate control of the vehicle 100.

As further explanation of the control trajectory 270 and how the planning system 170 implements the M PPI-CBF framework to generate the control trajectory 270, consider the following discussion.

The set of integers, real numbers, and positive real numbers are denoted as [symbol] , [symbol] , and [symbol] ⁺, respectively. The time derivative of x is denoted by x. Given x∈ [symbol] ⁿ, ∥x∥_{Q}:=\sqrt{x^{T}Qx} is called the weighted Q norm for a positive definite matrix Q· [symbol] a, b [symbol] =a^{T}b represents the inner product between a, b∈ [symbol] ⁿ. The interior and boundary of a set [symbol] is denoted by Int(C) and ∂C. A continuous function α:[0, α)→[0, ∞) is a class- [symbol] function if it is strictly increasing and α(0)=0. Furthermore, if α=∞ and lim_{r→∞}α(r)=∞, then it is called class- [symbol] _{∞}. Both

$$\frac{\partial }{\partial x}$$

and ∇ₓ denote gradient and will be used interchangeably depending on the complexity of expressions for easy understanding.

Consider the following discrete-time dynamics with state xₜ∈ [symbol] ⁿ, control input uₓ_{ₜ}∈ [symbol] ^{m}

xₜ₊₁=xₜ+F(xₜ,uₓ_{ₜ}) (1)
where F: [symbol] ⁿ× [symbol] ^{m}→ [symbol] ⁿ is the dynamics function. The following control-affine dynamics form.

xₜ₊₁=xₜ+ƒ(xₜ)+g(xₜ)uₓ_{ₜ} (2)

where ƒ: [symbol] ⁿ→ [symbol] ⁿ and [symbol] ⁿ→ [symbol] ^{n×m} are continuous functions. Let φ: [symbol] ⁿ→ [symbol] ^{p} project the robot state xₜ to its position φ(xₜ)∈ [symbol] ^{p}, the planning system 170 also denotes the robot body as a set valued function [symbol] (xₜ)⊂ [symbol] ^{p}, and the robot's surface (i.e., vehicle 100) as ∂ [symbol] (xₜ).

The state xₜ is required to lie in safe sets [symbol] ᵢ, i∈{1, . . . , N} that are defined to be 0-superlevel sets of a continuously differentiable constraint functions hᵢ: [symbol] ⁿ→

[symbol]

[symbol]

ᵢ≙{x∈ [symbol] :hᵢ(x)≥0} (3)

∂ [symbol] ᵢ≙{x∈ [symbol] :hᵢ(x)=0} (4)

Int( [symbol] ᵢ)≙{x∈ [symbol] :hᵢ(x)≥0} (5)

CBFs are a tool to enforce safety constraints in a controller. If hᵢ is a zeroing-barrier function for a class- [symbol] _{∞}, function vᵢ, then the following condition in discrete-time on hᵢ, called discrete-time CBF condition is sufficient for the forward invariance of the set [symbol] ᵢ:

$$\text{?} [ {h}_{i} ( {x}_{t + 1} ) - {h}_{i} ( {x}_{t} ) ] \geq {v}_{i} ( {h}_{i} ( {x}_{t} ) ) , ∀ x ∈ {𝒮}_{i} \qquad ( 6 )$$

In practice, equation (6) is imposed even if hᵢ is only a constraint function (a.k.a candidate CBF) and is not guaranteed to satisfy (6) for x∈ [symbol] ᵢ. For simplicity, in various configurations, the planning system 170 considers a special case of a linear class- [symbol] function vᵢ(x)=αᵢx, αᵢ∈ [symbol] ⁺. Intuitively, the CBF condition puts an upper bound on the rate at which the state xᵢ is allowed to approach safe set boundary. That is, it allows h(xₜ₊₁)<hₓ_{ₜ} when h(xₜ)>0 and requires h(xₜ₊₁)≥h(xₜ), when h(xₜ)=0. The rate is described by the parameter α. Owing to the difficulty of finding valid CBF for different performance characteristics (aggressive or conservative), a may be tuned offline.

A brief description of the M PPI algorithm is as follows: For a time horizon H, consider the state trajectory

$$x = {[ {x}_{t}^{T} , ... , {x}_{t + H}^{T} ]}^{T} ,$$

mean control input sequence

$$v = {[ {v}_{t}^{T} , ... , {v}_{t + H}^{T} ]}^{T} ,$$

v_{τ}∈ [symbol] ^{m} and injected Gaussian noise

$$w = {[ {w}_{t}^{T} , .. , {w}_{t + H}^{T} ]}^{T} ,$$

where w_{τ}~N(0, Σ_{w}) and where Σ_{w} is the noise covariance. Let the disturbed control input sequence be u=[uₜ, . . . , u_{t+H}]=v+w. The planning system 170 then employs M PPI to solve the following problem:

$${min}_{v} J ( v ) = \text{?} [ {\sum }_{τ = t}^{t + H - 1} Q ( {x}_{τ} , {u}_{τ} ) + ( \frac{λ}{2} {v}_{τ}^{T} {\sum }_{w}^{- 1} {v}_{τ} ) ] \qquad ( 7 a )$$

$$s . t . {x}_{τ + 1} = {x}_{τ} + F ( {x}_{τ} , {v}_{τ} + {w}_{τ} ) \qquad ( 7 b )$$

$${w}_{τ} ∼ \text{?} ( 0 , {\sum }_{w} ) \qquad ( 7 c )$$

where Q: [symbol] ⁿ× [symbol] ^{m} is a cost function designed to promote defined tasks, such as convergence to the target state or collision avoidance with an obstacle. In implementation, M PPI adopts a sampling-based approach to solving (7). Given a sample size K, the planning system 170 samples K control input perturbation sequences w^{k}, k∈{1, . . . , K} where each sequence is of size H, that is

$${w}^{k} = [ {w}_{t}^{k} , ... , {w}_{t + H}^{k} ] .$$

The control input sequence is then computed as u^{k}=v+w^{k}. For each sequence k, the control module 220 computes the states

$${x}_{τ}^{k} ,$$

τ∈[t, . . . , t+H] using dynamics equation (1).

The cost Sₖ of each trajectory k∈{1, . . . , K} is evaluated based on equation (7a) as follows:

$${S}_{k} = Φ ( {x}_{t + H}^{k} ) {\sum }_{τ = t}^{t + H - 1} Q ( {x}_{τ}^{k} ) + {γ ( {v}_{τ}^{k} )}^{T} {\sum }_{g}^{- 1} ( {v}_{τ}^{k} + {g}_{τ}^{k} ) \qquad ( 7 d )$$

where γ∈[0, λ]. The weight wₖ for k^{th} trajectory is determined as:

$${w}_{k} = exp ( - \frac{1}{λ} ( {S}_{k} - β ) ) \qquad ( 8 )$$

where

$$β = {min}_{k ∈ \{ 1 , ... , K \}}$$

Sₖ. The optimal control sequence is then computed as:

$${v}^{+} = {\sum }_{k = 1}^{K} {w}_{k} {u}^{k} / {\sum }_{k = 1}^{K} {w}_{k} \qquad ( 9 )$$

The cost functions are generally designed for specific objectives. For example, the planning system 170 implements cost metrics to quantify progress toward achieving two types of user-specified tasks, including, for example, convergence to a goal and collision avoidance.

Signed distance functions (SDFs) are employed by the planning system 170 to model the shape of the robot relative to aspects of the surrounding environment. This approach offers enhanced expressiveness for complex robot geometries (e.g., sedan vs. pickup truck vs. tractor trailer) and facilitates faster computation of distances to the environment with point-cloud observations. In particular, for a robot body [symbol] , the planning system 170 defines and SDF for the robot as φ: [symbol] ^{p} [symbol] [symbol] :

$$φ ( p ) := \{ \begin{matrix}- d ( p , \partial ℬ ) , & p ∈ ℬ \\ d ( p , \partial ℬ ) , & p ∉ ℬ\end{matrix} \qquad ( 10 )$$

where d denotes the Euclidean distance between a point and a set, and p∈ [symbol] ^{p} is a workspace point.

To accurately model the robot's shape using an SDF, the planning system 170 prepares a training dataset [symbol] derived from the robot's geometric description (e.g., URDF). This dataset consists of workspace points and their associated signed distances to the robot body. Specifically, the dataset includes samples of the form (p, d), where p∈ [symbol] ^{p} is a point in the workspace and d is the signed distance from p to the robot's surface ∂ [symbol] .

The planning system 170 defines a loss function to train the SDF model \hat{φ}(p; θ), parameterized by θ, as follows:

[symbol]

(θ; [symbol] )=l^{D}(θ; [symbol] )+λ_{E}l^{E}(θ; [symbol] ) (11)
where l^{D} is the distance loss, l^{E} is the Eikonal loss, and Δ_{E} is a tunable parameter that balances the two terms.

The distance loss

$${ℓ}_{i}^{D}$$

measures the mean squared error between the predicted signed distances and the ground truth distances

$${ℓ}^{D} ( θ ; 𝒟 ) = \frac{1}{\vert 𝒟 \vert} {\sum }_{p , d ) ∈ 𝒟} {( \hat{φ} ( p ; {θ}_{i} ) - d )}^{2} .$$

The Eikonal loss l^{E} enforces the property that the gradient of the SDF with respect to the input point p has unit norm almost everywhere, ensuring that the learned SDF behaves like a true distance function:

$${ℓ}^{E} ( θ ; 𝒟 ) = \frac{1}{\vert 𝒟 \vert} {{Σ}_{( q , p ) ∈ 𝒟} ( ‖ {∇}_{p} \hat{φ} ( p ; θ ) ‖ - 1 )}^{2} \qquad ( 12 )$$

As noted previously, instead of trying to impose the inequality constraint (6), the control module 220 implements the M PPI-CBF approach to impose the following equality constraint.

hᵢ(xₜ₊₁)−hᵢ(xₜ)=−α_{i,t}hᵢ(xₜ),∀i∈{1, . . . ,N} (13)

The control module 220 allows the parameter αᵢ to change with time (hence the notation α_{i,t} in equation (13)). The control module 220 achieves this by introducing a pseudo-parameter state \tilde{α}_{i,t} and and additional control inputs u_{α̅}_{i,t} in the following augmented state-space system.

$${\underbrace{[ \begin{matrix}{x}_{t + 1} \\ {\tilde{α}}_{t + 1}\end{matrix} ]}}_{{z}_{t + 1}} = {\underbrace{[ \begin{matrix}{x}_{t} \\ {\tilde{α}}_{t}\end{matrix} ]}}_{{z}_{t}} + [ \begin{matrix}F ( {x}_{t} , {u}_{{x}_{t}} ) \\ {u}_{{\tilde{α}}_{1 , t}}\end{matrix} ] \qquad ( 14 )$$

where

$${z}_{t} = [ {x}_{t}^{T} {\tilde{α}}_{t}^{T} ] ∈ {\text{?}}^{n + N} with {\tilde{α}}_{t}^{T} = {[ {\tilde{α}}_{1 , t} , … , {\tilde{α}}_{N , t} ]}^{T} and {u}_{t} = {[ {u}_{{x}_{t}}^{T} {u}_{{\overline{α}}_{t}}^{T} ]}^{T} , {u}_{{\overline{α}}_{t}} = {[ {u}_{{\overline{α}}_{1 , t}} , … , {u}_{{\overline{α}}_{N , t}} ]}^{T}$$

will be referred to as the augmented state and control input. It will be used in to compute the αₜ that will be imposed in the equality constraint equation (13) at time t. Specifically, the control module 220 implements parameter dynamics such that αₜ=\tilde{α}ₜ₊₁.

Note that the control module 220 allows \tilde{α}ₜ and \tilde{α} to vary in [symbol] ^{N}, that is, α_{i,t} can attain positive as well as negative values, which is necessary for the robot to move away from an obstacle (for collision avoidance) or towards the obstacle (in transient phase while making progress towards a goal state).

The control module 220 introduces at, instead of at, as the new state variable for the following reason. αₜ along with uₜ must be such that they satisfy equation (13) for i∈{1, . . . , N} simultaneously. The compatibility cannot be enforced if αₜ were a state variable that is guided by random control inputs sampled by M PPI. Also, note that αₜ cannot be treated as a control input (instead of a state variable) for the same reason specified above. Compatibility between equation (13) for i∈{1, . . . , N} would impose constraints on the choice of uₜ and αₜ, thereby precluding random Gaussian sampling that is part of M PPI.

Let

$${u}_{{x}_{τ}}^{′}$$

∈ [symbol] ^{m} and

$${u}_{{α}_{{α}_{t}}}^{′}$$

∈ [symbol] ^{N} be pseudo-inputs that are randomly sampled by M PPI and uₓ_{ₜ} and u_{α̅} are obtained from pseudo-inputs through a projection operation [symbol] : [symbol] ^{n+N}× [symbol] ^{m}× [symbol] ^{N}→ [symbol] ^{m}, [symbol] ^{N}. The dynamics under consideration for M PPI is the following:

$$[ \begin{matrix}{x}_{t + 1} \\ {\tilde{α}}_{t + 1}\end{matrix} ] = [ \begin{matrix}{x}_{t} \\ {\tilde{α}}_{t}\end{matrix} ] + [ \begin{matrix}F ( {x}_{t} , {u}_{{x}_{t}} ) \\ {u}_{{\overline{α}}_{1 , t}}\end{matrix} ] \qquad ( 15 a )$$

$${u}_{{x}_{t}} , {u}_{{\overline{α}}_{t}} = ℙ ( {z}_{t} , {u}_{{x}_{t}}^{′} , {u}_{{α}_{τ}}^{′} ) \qquad ( 15 b )$$

The projection operator [symbol] will project the randomly sampled control inputs to the set of allowed manifolds described by equality constraints equation (13).

To reiterate, the system of equations (13) might not have a solution for arbitrary values of uₓ_{ₜ} and αₜ. Therefore, the objective of designing [symbol] _{u,α} is to ensure compatibility of equation (13) for i∈{1, . . . , N}.

As such, let

$${u}_{x , t}^{′} and {u}_{\overline{α} , t - 1}^{′}$$

be randomly sampled control inputs from M PPI. The control module 220 projects the sampled control inputs to satisfy the manifold constraints with the following operation:

$$ℙ ( {z}_{t} , {u}_{{x}_{t}}^{′} , {u}_{{\overline{α}}_{t}}^{′} ) = \qquad ( 16 a )$$

$$arg {min}_{v , a} {‖ v - {u}_{x , t}^{′} ‖}_{{Q}_{1}} + {‖ a - {u}_{{\overline{α}}_{t}}^{′} ‖}_{{Q}_{2}} s . t . \qquad ( 16 b )$$

$${h}_{i} ( {x}_{t + 1} ) - {h}_{i} ( {x}_{t} ) = - ( {\tilde{α}}_{i , t} + {a}_{i} ) {h}_{i} ( {x}_{t} ) {∀}_{i} ∈ \{ 1 , … , N \} \qquad ( 16 c )$$

Note that α̅_{i,t}+aᵢ[=\tilde{α}_{i,t+1} and, therefore, by design of dynamics in equation (15b) \tilde{α}ₜ₊₁=αₜ.

The optimization of equation (16) might be too expensive to solve for generic dynamics function F. The following focuses on control affine dynamics in equation (2) under which equation (16) accepts an analytical solution. Under equation (2) and first-order Taylor series expansion of h(ƒ(xₜ)+g(xₜ)uₜ) about xₜ, provides:

$$h ( f ( {x}_{t} ) + ℊ ( {x}_{t} ) {u}_{t} ) - h ( {x}_{t} ) = \frac{\partial h}{\partial x} {\vert}_{{x}_{t}} ( f ( {x}_{t} ) + ℊ ( {x}_{t} ) {u}_{t} ) \qquad ( 17 )$$

Thus, the constraints in equation (16) are linear in u. The projection reduces to the following minimum norm problem subject to equality constraints.

$$ℙ ( {z}_{t} , {u}_{{x}_{t}}^{′} , {u}_{{\tilde{α}}_{t}}^{′} ) = \qquad ( 18 a )$$

$${arg min}_{v , a} {( z - {z}_{des} )}^{T} W ( z - {z}_{des} ) s . t . \qquad ( 18 b )$$

$${A}_{t} z = {b}_{t} \qquad ( 18 c )$$

where

$$z = [ \begin{matrix}v \\ a\end{matrix} ] , {z}_{des} = [ \begin{matrix}{u}_{x , t}^{′} \\ {u}_{{\tilde{α}}_{t}}^{′}\end{matrix} ] , W = diag ( {Q}_{1} , {Q}_{2} ) \qquad ( 19 )$$

$$A = [ \begin{matrix}{\frac{\partial {h}_{1}}{\partial x} \vert}_{{x}_{t}} ℊ ( {x}_{t} ) \\ {\frac{\partial {h}_{N}}{\partial x} \vert}_{{x}_{t}} ℊ ( {x}_{t} )\end{matrix} diag ( {h}_{1} ( {x}_{t} ) , … , {h}_{N} ( {x}_{t} ) ) ] , b = [ \begin{matrix}{- \frac{\partial {h}_{1}}{\partial x} \vert}_{{x}_{t}} f ( {x}_{t} ) \\ ⋮ \\ {- \frac{\partial {h}_{N}}{\partial x} \vert}_{{x}_{t}} f ( {x}_{t} )\end{matrix} ]$$

Equation (18c) is simply an instance of an equality constrained weighted minimum norm problem and the solution is given by:

z=z_{des}+W⁻¹A^{T}(AW⁻¹A^{T})⁻¹(b−Az_{des}) (20)

The control module 220 decomposes the M PPI stage-wise cost Q into two terms Q_{c} and Qₕ. Q_{c} is designed to promote convergence to the desired state and Qₕ is designed to ensure constraint satisfaction. The following explains the design of Qₕ.

A condition for constraint maintenance is given by Nagumo's theorem and states that whenever hᵢ(xₜ)=0, \dot{h}ᵢ(xₜ)≥0 or equivalently in discrete time h(xₜ₊₁)−h(xₜ)=−αₜh(x₊)≥0. Because of the discrete-time nature of the present implementation, instead of accounting for a constraint set boundary, the planning system 170 considers a buffer zone Dᵢ with buffer length dᵢ,

Dᵢ={x|0≤hᵢ(x)≤dᵢ} (21)

Inside this buffer zone, the control module 220 imposes the condition that αₜ<0 in equation (13) promotes positive \dot{h}ᵢ. The buffer length dᵢ is a tuning parameter in practice. Since α_{i,t}∈[−∞, ∞]), the planning system 170 explores possible ways in which the robot (i.e., the vehicle 100) can navigate around an obstacle, and invoke Nagumo's theorem near the boundary to ensure constraint satisfaction.

$${Q}_{h} ( {z}_{t} , {z}_{t + 1} , u ) = {Σ}_{i = 1}^{N} \text{?} [ ( {x}_{t} ∈ {D}_{i} ∩ {x}_{t} ∈ {\overline{𝒮}}_{i} ) \frac{{\overline{α}}_{i , t + 1}}{{h}_{i} ( x )} \qquad ( 22 )$$

Improvement of M PPI through CBF as implemented by the planning system 170 involves realizing inequality constraints through multiple novel aspects, including replacing inequality constraints with a set of equality constraints, where the set of equality constraints is specified by the additional state variable ã. Additionally, using the theory of planning on manifolds to impose the equality constraint is a further improvement.

As an example algorithmic approach of how the planning system 170 may implement the MPPI-CBF approach, consider the following pseudocode.
Inputs: zₜ, H, F, Q_{c}, which represent a current augmented state, time horizon, dynamics function, and a convergence cost.
1: Sample

$${w}^{k} = [ {w}_{1}^{k} , … , {w}_{H}^{k} ] ∼ N ( 0 , {Σ}_{ϵ} ) , ∀ k ∈ \{ 1 , … , K \}$$

2: u^{k}←v+∈^{k}
3: for k=1 to K do
4: Sₖ=0
5: for τ=0 to H do
6:

$${u}_{x , t}^{′} , {u}_{{\tilde{α}}_{t}}^{′} ←︀ {u}_{τ}^{k}$$

7: compute uₓ_{ₜ}, u_{α}_{ₜ} using uₓ_{ₜ} [symbol] from Equations (16) and (20)
8: compute next state z_{t+τ+1} using equation (15b)
9: compute Qₕ using equation (22)
10:

$${S}_{k} ← {S}_{k} + {Q}_{c} ( {x}_{t + τ}^{k} ) + {Q}_{h} + {γ ( {v}_{t + τ}^{m} )}^{T} {Σ}_{ϵ}^{- 1} ( {u}_{t + τ}^{m} )$$

11: End for
12: end for
13: w^{m}←compute weights according to equation (8)
14: v⁺←compute control trajectory as weighted average
15: return v⁺

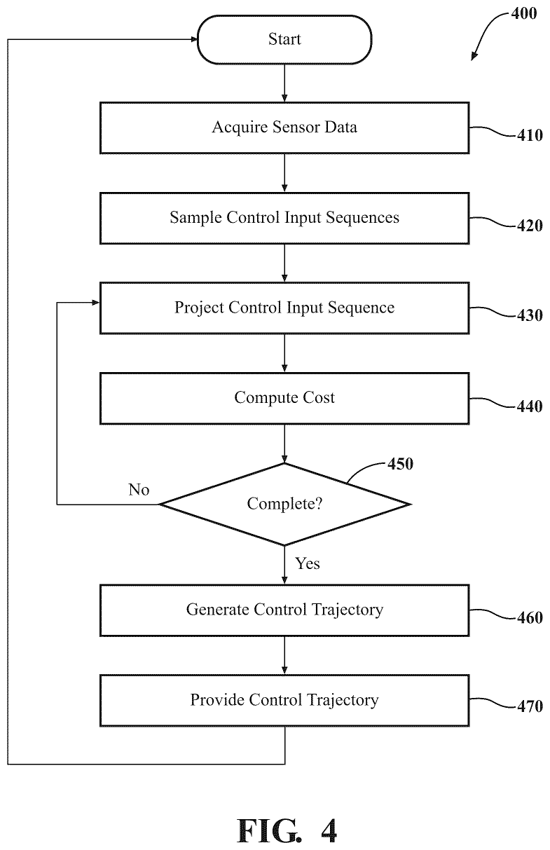

Additional aspects about generating control trajectories within the M PPI-CBF framework outlined herein will be described in relation to FIG. 4. FIG. 4 illustrates a flowchart of a method 400 that is associated with generating a control trajectory for a robotic device, such as a tractor trailer or other robotic device. Method 400 will be discussed from the perspective of the planning system 170 of FIGS. 1-2. While method 400 is discussed in combination with the planning system 170, it should be appreciated that the method 400 is not limited to being implemented within the planning system 170 but is instead one example of a system that may implement the method 400. Furthermore, while the method is illustrated as a generally serial process, various aspects of the method 400 can execute in parallel to perform the noted functions.

At 410, the control module 220 acquires the sensor data 250 about a surrounding environment of a device. In at least one arrangement, the control module 220 controls the sensor system 120 to acquire the sensor data 250. For example, the control module 220 controls the camera 126 of the vehicle 100 to observe the surrounding environment. Alternatively, or additionally, the control module 220 controls the camera 126 and the LiDAR 124 or another set of sensors to acquire the sensor data 250. As part of controlling the sensors to acquire the sensor data 250, it is generally understood that the sensors acquire the sensor data 250 of a region around the vehicle 100 with data acquired from different types of sensors generally overlapping in order to provide for a comprehensive sampling of the surrounding environment at each time step. In general, the sensor data 250 need not be of the exact same bounded region in the surrounding environment but should include a sufficient area of overlap such that distinct aspects of the area can be correlated. Thus, the control module 220, in one embodiment, controls the sensors to acquire the sensor data 250 of the surrounding environment.

Moreover, in further embodiments, the control module 220 controls the sensors to acquire the sensor data 250 at successive iterations or time steps. Thus, the planning system 170, in one embodiment, iteratively executes various aspects of the method 400 to acquire the sensor data 250 and provide information therefrom. Furthermore, the control module 220, in one embodiment, executes one or more of the noted functions in parallel for separate observations in order to maintain updated perceptions. Additionally, as previously noted, the control module 220, when acquiring data from multiple sensors, may fuse the data together to form the sensor data 250 and to provide for improved determinations of detection, location, and so on.

For example, as part of acquiring the sensor data 250 at block 410, the control module 220, in at least one arrangement, determines distances from the device to objects in the surrounding environment by deriving signed distance fields (SDFs) in relation to the device. That is, as noted previously, the planning system 170 may leverage an SDF model that models a geometry of the device (e.g., tractor trailer) from which distances relative to the surface of the SDF model between the device and aspects of the surrounding environment are determined by using the sensor data 250. In this way, the planning system 170 is better able to consider complex geometries of the device and ensure safety constraints are satisfied relative to the overall geometry of the device, which can be especially useful when the device is a tractor trailer and the trailer is likely to have different distances to the surrounding environment in comparison to the tractor.

At 420, the control module 220 samples control input sequences representing separate trajectories for navigating the device through the surrounding environment according to a control barrier function (CBF). That is, initially, in at least one approach, the control module 220 generates the trajectories or at least represents the possible trajectories for sampling based on current dynamics of the vehicle 100 along with the sensor data 250 about the surrounding environment. The trajectories are potential paths through the environment, which may or may not be efficient and/or safe (i.e., collision free). In any case, the control module 220 selects a sample of the trajectories, which may be according to a Gaussian distribution, in order to assess possible paths through the environment according to the M PPI-CBF process. In addition to generating and sampling trajectories, the control module 220 may further compute a next/subsequent state for the control input sequences at a subsequent time step in order to provide additional information about each separate trajectory. In essence, the computation of the next state is a prediction of to where the device would likely progress if following the specific trajectory.

At 430, the control module 220 projects the control input sequences sampled at 420 to satisfy an equality constraint. In general, the equality constraint defines manifolds of allowable inputs to constrain the sampling as defined by the CBF. That is, the constraints define manifolds within the state space, which are regions of permissible solutions. These manifolds are defined in accordance with the equality constraints per the CBF. Thus, the control module 220 projects the input sequences onto the manifolds to enforce the equality constraints and ensure that the sampled input sequences do not violate the constraints (e.g., that the input sequences do not cause collisions with aspects of the environment). To achieve this, the control module 220 applies a projection function, as defined previously. The projection function is state dependent and, in at least one arrangement, incorporates the alpha parameter, which is a dynamic value that contributes to exploration of the state space to facilitate varying the output.

At 440, the control module 220 determines costs for the control input sequences according to model predictive path integral (M PPI). That is, for example, the control module 220 computes a safety cost and a convergence cost for each sampled and projected input sequence. The safety cost promotes a positive barrier rate according to at least a current state, and a next state to facilitate enforcing safety of the device, whereas the convergence cost promotes convergence to a desired state. As part of the cost computation, the control module 220 further applies a pseudo parameter state that varies with time to promote diversity of a search space for the control trajectory. Additionally, the control module 220, in one arrangement, uses the distances from the SDFs to assess costs of the trajectory relative to obstacles in the environment.

At 450, the control module 220 determines whether additional timesteps for a present input sequence remain. If so, then the control module 220 repeats the projection and computation for the next timestep. Otherwise, the control module 220 determines whether additional input sequences remain from the original samples. If further sampled input sequences remain, then the control module 220 repeats the process for the subsequent samples. Otherwise, the control module 220 proceeds compute the control trajectory at 460.

At 460, the control module 220 determines a control trajectory. In at least one arrangement, the control module 220 initially determines the weights from the computed costs. The control module 220 uses the weights of each separate control input sequence as the assigned weight for that respective sequence. The control module 220 can then compute the weighted average over all of the control input sequences using the respective weights. This weighted average of the control input sequences is the control trajectory 270 for a current timestep.

At 470, the control module 220 provides the control trajectory 270. In one approach, the control module 220 provides the control trajectory 270 by using the control trajectory 270 to control the device via a controller. The control trajectory 270 provides for navigating the surrounding environment in a safe manner that avoids collisions with aspects of the environment even when the device has a complex geometry, such as a tractor trailer. Thus, the control module 220 may use the control trajectory 270 to autonomously control the vehicle 100. Alternatively, the control module 220 can use the control trajectory 270 to provide control inputs or control support for other levels of automation, such as SA E levels 1-5. In further approaches, the control module 220 provides the control trajectory 270 to a planner of the vehicle 100 to facilitate trajectory planning.

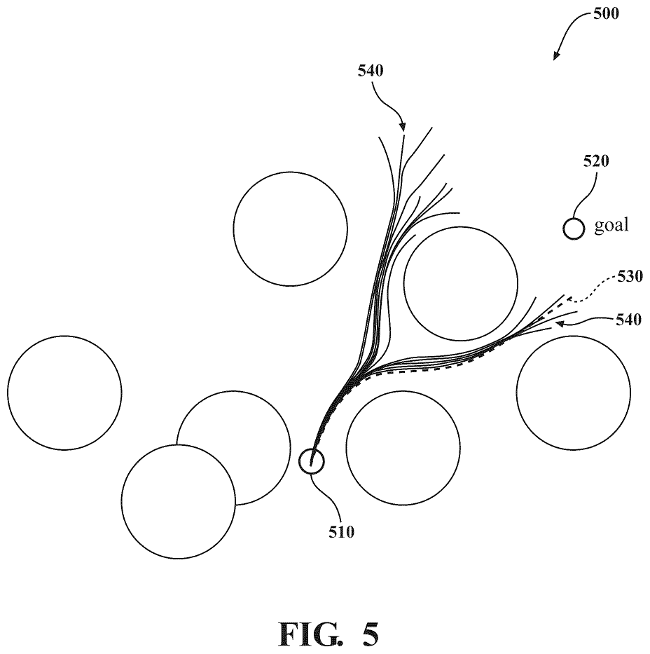

As further explanation of how the planning system 170 generates the control trajectory using the present approach, consider FIG. 5. FIG. 5 illustrates an example scenario 500 of a robot navigating obstacles, which are represented as the black circles, to reach a goal 520. A dashed line 530 represents the control trajectory 270 that the planning system generates based on the plurality of sampled sequences 540. Thus, the planning system 170 samples the sequences and projects the sequences onto the manifolds representing safe/permissible trajectories through the defined space. The planning system 170 then computes the costs of each separate trajectory and computes the weighted average to arrive at the control trajectory 530. As can be seen from the dispersion of the sampled trajectories 540, the planning system weighs the group surrounding the control trajectory 530 higher than the unaligned group in order to arrive at the final control trajectory 530, thereby avoiding the obstacles while also determining an efficient trajectory for reaching the goal 520.

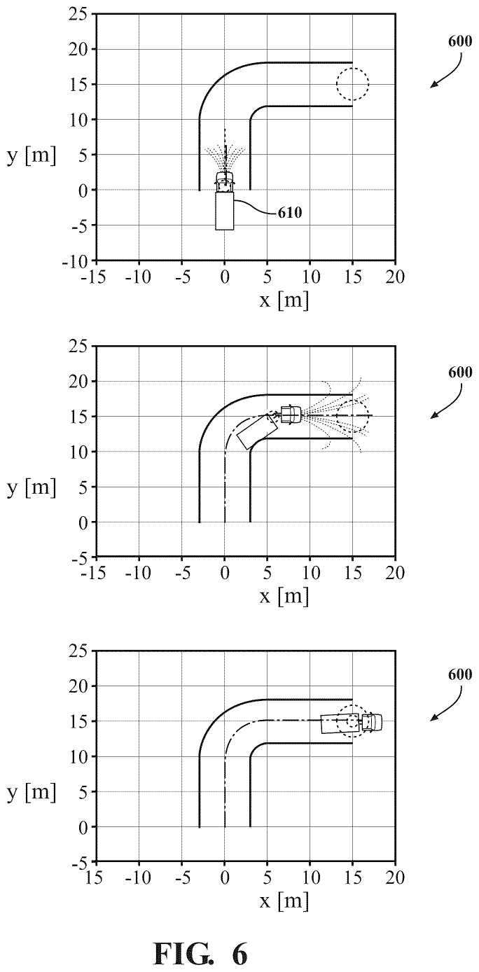

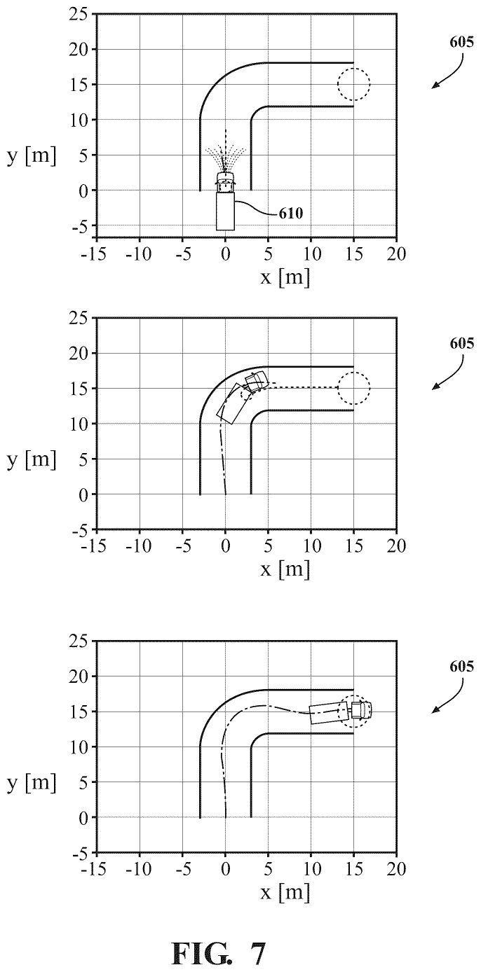

Turning to FIGS. 6-7, two separate occurrences 600 and 605 of the same scenario are shown. In each scenario, a tractor trailer 610 is shown navigating a curve. However, in 600, the planning system 170 is not engaged, whereas in 605 the planning system 170 is engaged. Thus, a planner associated with scenario 600 does not employ the same approach as scenario 605. Therefore, in 600 (a) the tractor trailer 610 is approaching a curve and, as shown, is considering a myriad of possible trajectories. These trajectories are not limited to feasible/safe trajectories, but instead include trajectories that exit the roadway and/or may cause collisions. As a result, in 600 (b), the tractor trailer 610 contacts an edge of the road, which may be a curb, and thus exceeds the constraints of the roadway before reaching the goal state in 600 (c).

By contrast, by using the planning system 170, the tractor trailer 610, in 605 (a), considers only trajectories that project within the manifolds of acceptable/feasible trajectories. As shown in 605 (b), this results in the tractor trailer 610 successfully maneuvering around the corner without colliding with the edge of the roadway or driving off of the roadway itself before reaching the goal in 605 (c). Consequently, by implementing the planning system 170 to consider the full geometry of the tractor trailer 610 using the SDF model, by further constraining the sampled input sequences according to the equality constraints of the CBF and then determining the control trajectory in the noted manner, the planning system 170 is able to safely navigate the tractor trailer 610 to the goal state.

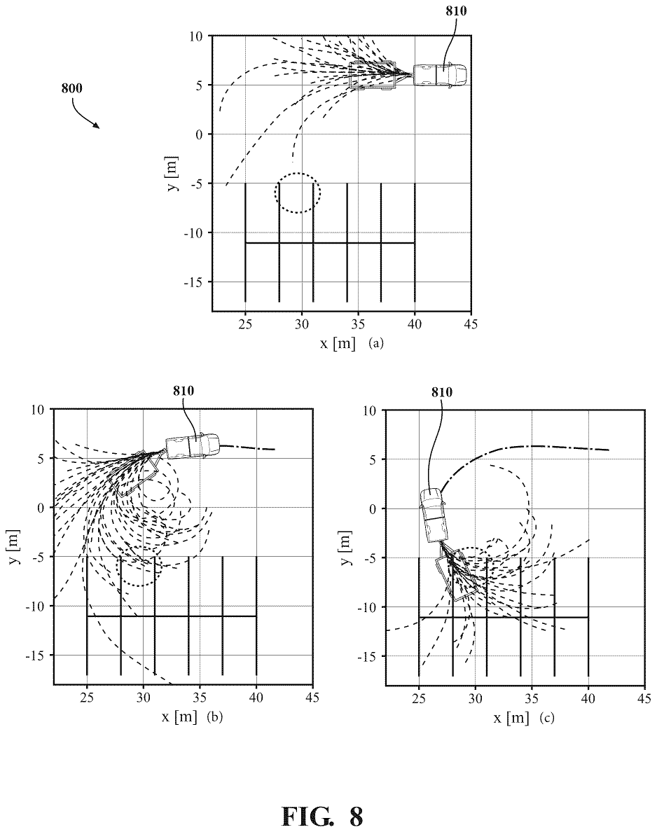

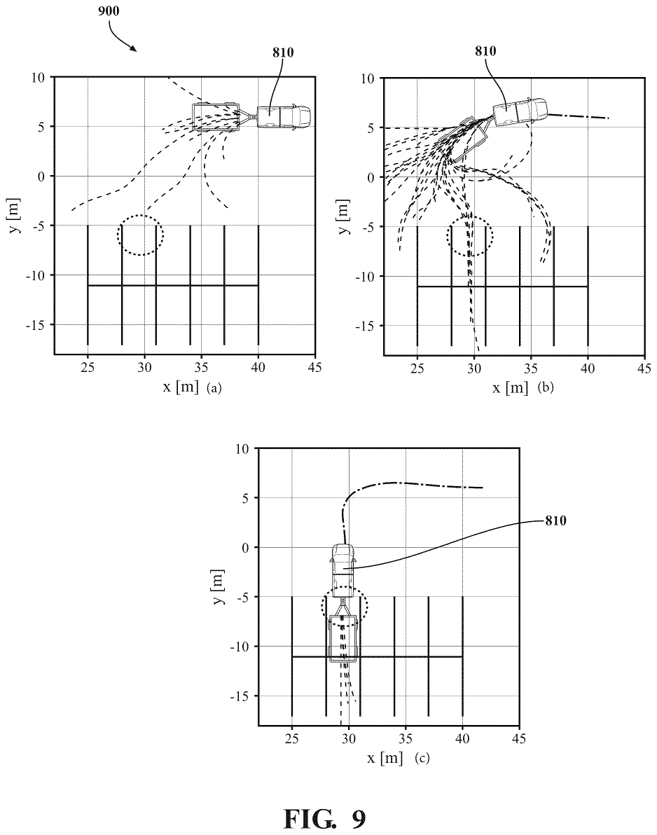

FIGS. 8 and 9 show two separate occurrences 800 and 900 of the same scenario but with different controllers implemented. In each scenario, an articulated vehicle 810 (e.g., a tractor trailer, a pickup truck with a trailer, etc.) is shown backing into a parking space. However, in 800, the planning system 170 is not engaged, whereas in 800 the planning system 170 is engaged. Thus, a planner associated with scenario 810 does not employ the same approach as scenario 800. Therefore, in 800 (a) the articulated vehicle 810 is reversing toward a sparking spot and, as shown, is considering a myriad of possible trajectories. These trajectories are not limited to feasible/safe trajectories but instead include trajectories that extend away from the parking spot and may lead to movements that miss the parking space, thereby potentially resulting in a collision. As a result, in 800 (b), the articulated vehicle 810 has overshot the parking space, thereby causing the vehicle 810 to miss the parking spot in 800 (c). In various instances, if another vehicle was present in an adjacent spot, the trajectory could result in a collision.

By contrast, by using the planning system 170, the articulated vehicle 810, in 900 (a), considers only trajectories that project within the manifolds of acceptable/feasible trajectories. As shown in 900 (b), this results in the articulated vehicle 810 successfully maneuvering toward the parking spot and reaching the goal in 900 (c) without exceeding the boundary of the parking spot. Consequently, by implementing the planning system 170 to consider the full geometry of the articulated vehicle 810 using the SDF model, by further constraining the sampled input sequences according to the equality constraints of the CBF and then determining the control trajectory in the noted manner, the planning system 170 is able to safely navigate the articulated vehicle 810 to the goal state within the parking spot without violating the parking space boundaries.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Of course, in further aspects, the vehicle 100 may be a manually driven vehicle that may or may not include one or more driving assistance systems, such as active cruise control, lane-keeping assistance, crash avoidance, and so on. In any case, “manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills, etc. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include various types of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element, or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the planning system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement, speed, maneuvering, heading, direction, etc. of the vehicle 100. The processor(s) 110, and/or the automated driving module(s) 160 may control some or all of these vehicle systems 140 and, thus, may be partially or fully autonomous.

The processor(s) 110, and/or the automated driving module(s) 160 can be operatively connected to communicate with the various vehicle systems 140 and/or individual components thereof. For example, returning to FIG. 1, the processor(s) 110, the planning system 170, and/or the automated driving module(s) 160 can be in communication to send and/or receive information from the various vehicle systems 140 to control the movement, speed, maneuvering, heading, direction, etc. of the vehicle 100. The processor(s) 110, the planning system 170, and/or the automated driving module(s) 160 may control some or all of these vehicle systems 140.

The processor(s) 110, and/or the automated driving module(s) 160 may be operable to control the navigation and/or maneuvering of the vehicle 100 by controlling one or more of the vehicle systems 140 and/or components thereof. For instance, when operating in an autonomous mode, the processor(s) 110, and/or the automated driving module(s) 160 can control the direction and/or speed of the vehicle 100. The processor(s) 110, and/or the automated driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the automated driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine the position and velocity of the vehicle 100. The automated driving module(s) 160 can determine the location of obstacles, obstacles, or other environmental features, including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the planning system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

1. A planning system, comprising:
one or more processors; and
a memory communicably coupled to the one or more processors and storing:
a control module including instructions that, when executed by the one or more processors, cause the one or more processors to:
acquire sensor data about a surrounding environment of a device;
sample control input sequences representing separate trajectories for navigating the device through the surrounding environment according to a control barrier function (CBF) and the sensor data, wherein the instructions to sample the control input sequences includes instructions to project the control input sequences to analytically map the control input sequences onto manifolds that define feasible solutions according to an equality constraint of the CBF prior to determining costs for the control input sequences;
determine costs for the control input sequences according to model predictive path integral (MPPI);
determine a control trajectory according to a weighted average of the control input sequences based, at least in part, on the costs; and
provide the control trajectory.

2. The planning system of claim 1, wherein the instructions to sample the control input sequence include instructions to project the control input sequences to satisfy an equality constraint, where the equality constraint defines manifolds of allowable inputs to constrain the sampling as defined by the CBF, and
wherein the instructions to project the control inputs include instructions to apply a projection function that is state dependent to motion of the device along manifolds.

3. The planning system of claim 1, wherein the instructions to determine the control trajectory include instructions to compute a next state for the control input sequences at a subsequent time step, and
wherein the instructions to determine the costs include instructions to compute the cost to promote a positive barrier rate for the control input sequences projected onto the manifolds defined by the equality constraint of the CBF.

4. The planning system of claim 1, wherein the instructions to determine the costs include instructions to compute a safety cost that promotes a positive barrier rate according to at least a current state, and a next state to enforce safety of the device, and compute a convergence cost that promotes convergence to a desired state.

5. The planning system of claim 1, wherein the instructions to determine the control trajectory according to the weighted average include instructions to weigh the control input sequences using the costs and average weighted inputs to generate the control trajectory, and
wherein the instructions to determine the costs include instructions to apply a pseudo parameter state that varies with time to promote diversity of a search space for the control trajectory.

6. The planning system of claim 1, further comprising instructions to:
determine distances from the device to objects in the surrounding environment according to the sensor data by deriving signed distance fields in relation to the device.

7. The planning system of claim 1, wherein the instructions to provide the control trajectory include instructions to control the device according to the control trajectory to navigate the surrounding environment.

8. The planning system of claim 1, wherein the device is a tractor trailer that autonomously follows the control trajectory.

9. A non-transitory computer-readable medium storing instructions that, when executed by one or more processors, cause the one or more processors to:
acquire sensor data about a surrounding environment of a device;
sample control input sequences representing separate trajectories for navigating the device through the surrounding environment according to a control barrier function (CBF) and the sensor data, wherein the instructions to sample the control input sequences includes instructions to project the control input sequences to analytically map the control input sequences onto manifolds that define feasible solutions according to an equality constraint of the CBF prior to determining costs for the control input sequences;
determine costs for the control input sequences according to model predictive path integral (MPPI);
determine a control trajectory according to a weighted average of the control input sequences based, at least in part, on the costs; and
provide the control trajectory.

10. The non-transitory computer-readable medium of claim 9, wherein the instructions to sample the control input sequence include instructions to project the control input sequences to satisfy an equality constraint, where the equality constraint defines manifolds of allowable inputs to constrain the sampling as defined by the CBF, and
wherein the instructions to project the control inputs include instructions to apply a projection function that is state dependent to motion of the device along manifolds.

11. The non-transitory computer-readable medium of claim 9, wherein the instructions to determine the control trajectory include instructions to compute a next state for the control input sequences at a subsequent time step.

12. The non-transitory computer-readable medium of claim 9, wherein the instructions to determine the costs include instructions to compute a safety cost that promotes a positive barrier rate according to at least a current state, and a next state to enforce safety of the device, and compute a convergence cost that promotes convergence to a desired state.

13. The non-transitory computer-readable medium of claim 9, wherein the instructions to determine the control trajectory according to the weighted average include instructions to weigh the control input sequences using the costs and average weighted inputs to generate the control trajectory, and
wherein the instructions to determine the costs include instructions to apply a pseudo parameter state that varies with time to promote diversity of a search space for the control trajectory.

14. A method, comprising:
acquiring sensor data about a surrounding environment of a device;
sampling control input sequences representing separate trajectories for navigating the device through the surrounding environment according to a control barrier function (CBF) and the sensor data, wherein sampling the control input sequences comprises projecting the control input sequences to analytically map the control input sequences onto manifolds that define feasible solutions according to an equality constraint of the CBF prior to determining costs for the control input sequences;
determining costs for the control input sequences according to model predictive path integral (MPPI);
determining a control trajectory according to a weighted average of the control input sequences based, at least in part, on the costs; and
providing the control trajectory.

15. The method of claim 14, wherein sampling the control input sequence includes projecting the control input sequences to satisfy an equality constraint where the equality constraint defines manifolds of allowable inputs to constrain the sampling as defined by the CBF, and
wherein projecting the control inputs includes applying a projection function that is state dependent to motion of the device along manifolds.

16. The method of claim 14, wherein determining the control trajectory includes computing a next state for the control input sequences at a subsequent time step.

17. The method of claim 14, wherein determining the costs includes computing a safety cost that promotes a positive barrier rate according to at least a current state, and a next state to enforce safety of the device, and computing a convergence cost that promotes convergence to a desired state.

18. The method of claim 14, wherein determining the control trajectory according to the weighted average includes weighing the control input sequences using the costs and average weighted inputs to generate the control trajectory, and
wherein determining the costs includes applying a pseudo parameter state that varies with time to promote diversity of a search space for the control trajectory.

19. The method of claim 14, further comprising:
determining distances from the device to objects in the surrounding environment according to the sensor data by deriving signed distance fields in relation to the device.

20. The method of claim 14, wherein providing the control trajectory includes controlling the device according to the control trajectory to navigate the surrounding environment, and wherein the device is a tractor trailer.
